(19) United States
(12) Patent Application Publication
(10) Pub. No.: US 2005/0044796 A1
(43) Pub. Date: Mar. 3, 2005

(54) Door glass guide of a vehicle

(76) Inventor: Chang Ho Kim, Seoul (KR)

Correspondence Address: MORGAN, LEWIS & BOCKIUS, LLP., 2 PALO ALTO SQUARE, 3000 EL CAMINO REAL, PALO ALTO, CA, 94306, US

(21) Appl. No.: 10/747,891

(22) Filed: Dec. 29, 2003

(30) Foreign Application Priority Data
Sep. 2, 2003 (KR) 10-2003-0061118

(51) Int. Cl. B60J 1/16

(52) U.S. Cl. 49/374

(57) ABSTRACT

A door glass guide for vehicles includes a glass guide mounted and vertically fixed to a door panel. A garnish is joined to an upper end of the glass guide and vertically arranged and an elastic run channel is internally secured starting from an upper end of the garnish and extending to a lower end of the glass guide. A stabilizing assembly is mounted to the upper end of the glass guide and encompasses a lower outer surface of the garnish.

### CROSS-REFERENCE TO RELATED APPLICATIONS

This application claims priority to Korean Application No. 10-2003-0061118, filed Sep. 2, 2003, the disclosure of which is incorporated fully herein by reference.

### FIELD OF THE INVENTION

Generally, the present invention relates to a vehicle door glass guide. More particularly, the door glass guide has an upper region of a glass guide and a lower region of a garnish connected such that play between these elements is prevented by a stabilizing assembly.

### BACKGROUND OF THE INVENTION

Typically, a door glass guide is mounted to a rear area of a door. The door glass guide acts to guide and make the raising and lowering of a door glass, by a regulator, smooth. The conventional door glass guide includes a glass guide mounted to be vertically fixed to a door panel. Also, a garnish is joined to an upper end of the glass guide to be vertically arranged and an elastic run channel is internally secured. The elastic run channel extends starting from an upper end of the garnish and extends to a lower end of the glass guide.

In the conventional door glass guide for a vehicle, when a door glass is raised and lowered such that it partially enters and exits the door panel, a rear area of the door glass is supported by the glass guide and the garnish. Also, the door glass is guided, while being raised and lowered, by the run channel, which is inserted into grooves of the glass guide and the garnish. In addition, the run channel maintains an airtight and watertight seal between the door glass and the garnish and, therefore, acts to absorb vibrations of the door glass that are generated when the door is opened and closed and during vehicle operation.

However, a drawback of the conventional door glass guide for vehicles is that when there is play between the lower region of the garnish and the upper region of the glass guide, the run channel interferes with the raising and lowering of the door glass, such that the same becomes worn and noise is generated.

### SUMMARY OF THE INVENTION

In an embodiment of the present invention, there is provided a door glass guide with improved wear resistance and functionality.

In another embodiment of the present invention, a door glass guide for a vehicle includes a glass guide mounted to be vertically fixed to a door panel. A garnish is joined to an upper end of the glass guide to be vertically arranged. Further, an elastic run channel is internally secured starting from an upper end of the garnish and extending to a lower end of the glass guide. A stabilizing assembly is mounted to the upper end of the glass guide and encompasses a lower outer surface of the garnish.

### BRIEF DESCRIPTION OF THE DRAWINGS

The accompanying drawings illustrate an exemplary embodiment of the present invention, and, read together with the description, serve to explain the principles of the present invention.

FIG. 1 is a perspective view of a door glass guide for a vehicle according to an embodiment of the present invention; and

FIG. 2 is a perspective view of a stabilizing assembly shown connected to the door glass guide of FIG. 1.

### DETAILED DESCRIPTION OF THE PREFERRED EMBODIMENTS

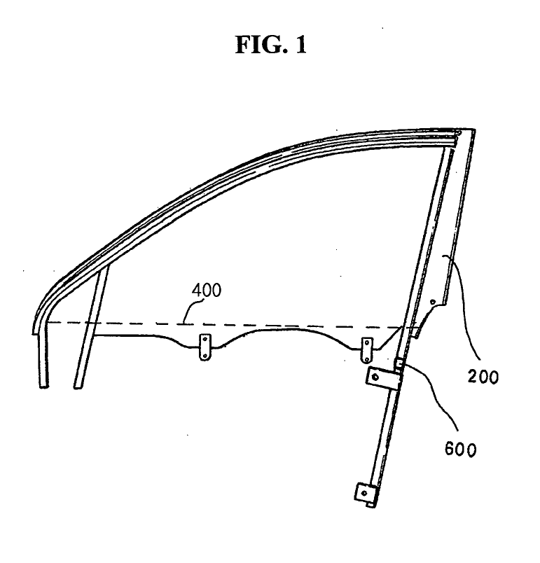

FIG. 1 shows the door glass guide includes a glass guide 100 mounted and vertically fixed to a door panel 400. A garnish 200 is joined to an upper end of the glass guide 100 and vertically arranged. An elastic run channel 300 is internally secured, starting from an upper end of the garnish 200 and extending to a lower end of the glass guide 100. A stabilizing assembly 600 is mounted to the upper end of the glass guide 100 and encompasses a lower outer surface of the garnish 200.

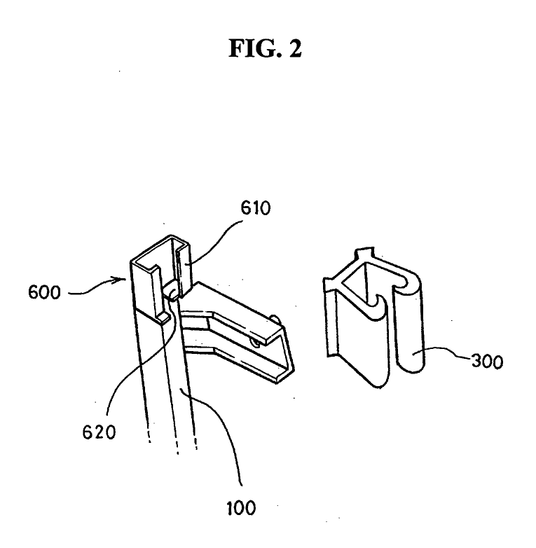

The stabilizing assembly 600, FIG. 2, includes a contact member 620 formed on a lower end of the stabilizing assembly 600. The contact member 620 contacts an upper end of the glass guide 100 and a connector 610 formed on an upper end of the stabilizing assembly 600. The connector 610 encompasses the lower outer surface of the garnish 200. With this configuration, that is, with the contact member 620 of the stabilizing assembly 600 fixed to the upper end of the glass guide 100 and the connector 610 of the stabilizing assembly 600 connected encompassing the lower end of the garnish 200, play between the upper end of the glass guide 100 and the lower end of the garnish 200 is minimized.

Accordingly, a rear area of a door glass 500 is supported by the glass guide 100 and the garnish 200 when the door glass 500 is raised and lowered to enter and exit the door panel. The run channel 300 is inserted into a groove of the glass guide 100 and the garnish 200 such that it does not interfere with the movement of the door glass 500. The end result is that the run channel 300 does not become worn and sound is not generated even when the door glass 500 is raised and lowered. Thereby, the overall operation of the door glass guide is improved.

In the present invention described above, the stabilizing assembly is mounted to the upper end of the glass guide in a state encompassing the lower outer surface of the garnish. Therefore, there is virtually no play between the upper end of the glass guide and the lower end of the garnish. Furthermore, even when the door glass is raised and lowered and caused to enter and exit the door panel, the rear area of the door glass is supported by the glass guide and the garnish. The run channel is inserted into a groove of the glass guide and the garnish such that it does not interfere with the movement of the door glass. Hence, the run channel does not become worn and sound is not generated even when the door glass is raised and lowered.

Although an embodiment of the present invention has been described in detail hereinabove in connection with a certain exemplary embodiment, it should be understood that the invention is not limited to the disclosed exemplary embodiment, but, on the contrary is intended to cover various modifications and/or equivalent arrangements included within the spirit and scope of the present invention, as defined in the appended claims.

1. A door glass guide for a vehicle, comprising:
a glass guide mounted to be vertically fixed to a door panel;
a garnish joined to an upper end of the glass guide to be vertically arranged;
an elastic run channel internally secured starting from an upper end of the garnish and extending to a lower end of the glass guide; and
a stabilizing assembly mounted to the upper end of the glass guide and encompassing a lower outer surface of the garnish.

2. The door glass guide of claim 1, wherein the stabilizing assembly includes a contact member formed on a lower end of the stabilizing assembly that contacts an upper end of the glass guide, and a connector formed on an upper end of the stabilizing assembly that encompasses a lower outer surface of the garnish.
